(19) United States
(12) Patent Application Publication
(10) Pub. No.: US 2024/0172336 A1
(43) Pub. Date: May 23, 2024

(54) DRIVER TOPOLGY AND OPERATION FOR AN INDUCTIVE COOKTOP

(71) Applicant: GHSP, Inc., Holland, MI (US)

(72) Inventors: Benjamin Moes, Caledonia, MI (US); Marc Smeyers, Zeeland, MI (US)

(21) Appl. No.: 18/058,054

(22) Filed: Nov. 22, 2022

(51) Int. Cl. H05B 6/12; H05B 6/36; H05B 6/44

(52) U.S. Cl. CPC H05B 6/1272; H05B 6/365; H05B 6/44

(57) ABSTRACT

An inductive cooktop includes a transparent panel arranged to support a cookware object and an induction coil layer below the transparent panel. The induction coil layer includes a plurality of induction coils and a plurality of drivers in electronic communication with the induction coils. The induction coil layer is configured to operate adjacent induction coils to create adjacent electromagnetic fields having opposite polarity. Adjacent induction coils may be driven with current equal in amplitude and opposite in phase. Adjacent induction coils may be formed having windings oriented in opposite direction and driven in symmetrical phase.

### TECHNICAL FIELD

The present disclosure relates generally to an inductive cooktop system with a display, and more specifically to driver topology for operating inductive coils of an inductive cooktop system.

### BACKGROUND

Kitchens or other areas used to prepare and cook food may have an inductive cooktop, such as a cooktop that is part of a range unit or a separate cooktop unit that is placed on or installed directly in a countertop or other work surface. It is known that inductive cooktops can be used to effectively heat metal cookware that is capable of inductive coupling with a time varying electromagnetic (EM) field generated by the cook top.

It is common for inductive cooktops to have a top panel that supports cookware on the cooktop, such that during use, the top panel is often conductively heated by the inductively heated cookware. The residual heat at the top surface of the top panel is often dangerous to touch and is difficult and sometime unable to be visibly recognized. Presently known measures for operating induction coils of an inductive cooktop can result in inefficiencies where a subset of the coils are powered during operation of the cooktop and another subset of coils are not powered during operation of the cooktop.

Attempts to selectively power certain coils of an inductive cooktop can encounter several issues, such as those related to the energy losses by generating reactive current flow in unpowered coils adjacent to powered coils. The resultant current in unpowered coils can also cause interference or other conflict with data transmissions of the display and other electronics.

### SUMMARY

The present disclosure provides an inductive cooktop system and corresponding methods for operating an inductive cooktop. An inductive cooktop has a transparent panel configured to support a cookware object. The inductive cooktop includes a transparent panel configured to support a cookware object. The inductive cooktop includes an induction coil layer disposed below the transparent panel. The induction coil layer is operable to generate a time varying electromagnetic field that inductively couples with the cookware object supported at the transparent panel. The induction coil layer includes a plurality of induction coils configured to operate a first coil to generate a first electromagnetic field of a first magnitude and first polarity and to operate a second coil to generate a second electromagnetic field of a second magnitude and second polarity, the second coil being adjacent the first coil, the first magnitude being equal the second magnitude, and the first polarity being opposite the second polarity.

In some examples, the inductive cooktop includes a plurality of drivers in electronic communication with the plurality of induction coils. A first driver may be connected in series with the first coil and the second coil. The first coil may include windings oriented in a first direction and the second coil may include windings oriented in a second direction opposite the first direction.

In some examples, the inductive cooktop may include a plurality of drivers in electronic communication with the plurality of induction coils. The first driver may be connected in series with a first terminal of the first coil. A second terminal of the first coil may be connected in series to a first terminal of the second coil. The second terminal of the first coil may be the same polarity as the first terminal of the second coil. In one example, the second terminal of the first coil and the first terminal of the second coil may be the positive terminal, so that the positive terminal of the first coil is connected to the positive terminal of the second coil.

In some examples, the first coil may be driven with a first current having a first frequency and first phase. The second coil may be driven with a second current having a second frequency and second phase. The first phase may be opposite the second phase so that the polarity of an electromagnetic field of the first coil is opposite the polarity of an electromagnetic field of the second coil.

In some examples, the first coil and the second coil may be formed on a common E-shape ferrite core. The common E-shape ferrite core may include a first end vertical arm member, e, a horizontal portion extending between the first end vertical arm member and second end vertical arm member, and a first interstitial vertical arm member extending from the horizontal portion disposed between the first end vertical arm member and the second end vertical arm member. A first coil may be formed between the first end vertical arm member and the first interstitial vertical arm member, and a second coil formed between the first interstitial vertical arm member and the second end vertical arm member. The first coil may include windings around the horizontal portion wound in a first direction and the second coil may include windings around the horizontal portion wound in a second direction opposite the first direction.

In some examples, the inductive cooktop includes a plurality of drivers in electronic communication with the plurality of induction coils. The plurality of induction coils and plurality of drivers includes a circuit including a first driver, a first coil, a second coil and a second driver connected in series. A third driver is connected at the junction between first coil and the second coil. In some examples, the circuit further includes a third coil connected in series between the second coil and the second driver; and a fourth driver connected at the junction between the second coil and the third coil.

In some examples, the circuit further includes a fourth coil disposed in series between the third coil and the second driver; and a fifth driver connected at the junction between the third coil and the fourth coil.

In some examples, the circuit includes a first resonant capacitor disposed in series between the first driver and the first coil; a second resonant capacitor disposed in series between the second coil and the third driver; and a third resonant capacitor disposed in series between the third coil and the third driver.

In some examples, the first coil includes a U-shape ferrite core comprising a first vertical arm member and second vertical arm members and a horizontal portion extending between the first and second vertical arm members; and a conductive wire wound around the vertical portion. In some examples, the first coil, the second coil, and the third coil are formed on a common E-shape ferrite core. In some examples, the common ferrite core includes a first end vertical arm member; a second end vertical arm member, and a horizontal portion extending between the first end and second end vertical arm members. A first interstitial vertical arm member may extend from the horizontal portion disposed between the first coil and the second coil. A second interstitial vertical arm member may extend from the horizontal portion disposed between the second coil and the third coil. The first coil may include windings around the horizontal portion wound in a first direction. The second coil may include windings around the horizontal portion would in a second direction, the second direction being opposite the first direction. The third coil may include windings around the horizontal portion would in a third direction, the third direction being the same as the first direction.

In some examples, the circuit is a first circuit and the inductive cooktop may further comprising a second circuit. The second circuit may include a fifth driver, a fourth coil, a fifth coil, a sixth coil and a sixth driver connected in series. A seventh driver may be connected at the junction of the fourth coil and the fifth coil. An eighth driver may be connected at the junction of the fifth coil and the sixth coil. In some examples, the first coil is adjacent the fourth coil, the second coil is adjacent the fifth coil, and the third coil is adjacent the sixth coil in the induction coil layer.

A method of operating an induction cooktop is provided. The induction cooktop may include a transparent panel configured to support a cookware object and an induction coil layer disposed below the transparent panel. The coil layer may include a first circuit. The first circuit may include a first driver, a first coil, a second coil, a third coil and a second driver connected in series. A third driver may be connected at the junction between first coil and the second coil. A fourth driver may be connected at the junction between the second coil and the third coil. The induction cooktop may include a second circuit including a fifth driver, a fourth coil, a fifth coil, a sixth coil and a sixth driver connected in series. A seventh driver may be connected at the junction of the fourth coil and the fifth coil. An eighth driver may be connected at the junction of the fifth coil and the sixth coil. The method includes driving the first coil with the first driver operating at a first polarity and the third driver operating at a second polarity opposite the first polarity. The method includes driving the fourth coil with the fifth driver operating at the second polarity and the seventh driver operating at the first polarity.

In some examples, the method may include driving the third coil with the fourth driver operating at the second polarity and the second driver operating at the first polarity, wherein the voltage across the second coil is substantially zero. The method may include driving the sixth coil with the eighth driver operating at the first polarity and the sixth driver operating at the second polarity, wherein the voltage across the fifth coil is substantially zero.

An alternative method of operating an induction cooktop is provided. The induction cooktop includes a transparent panel configured to support a cookware object and an induction coil layer disposed below the transparent panel. The coil layer may include a first circuit including a first driver, a first coil, a second coil, a third coil and a second driver connected in series. A third driver may be connected at the junction between first coil and the second coil. A fourth driver may be connected at the junction between the second coil and the third coil. The induction cooktop may include a second circuit including a fifth driver, a fourth coil, a fifth coil, a sixth coil and a sixth driver connected in series. A seventh driver may be connected at the junction of the fourth coil and the fifth coil. An eighth driver may be connected at the junction of the fifth coil and the sixth coil. The method includes driving the first coil and the second coil with the first driver operating at a first polarity and the fourth driver operating at a second polarity opposite the first polarity. The method includes driving the fourth coil and the fifth coil with the fifth driver operating at the second polarity and the eighth driver operating at the first polarity.

Each of the above independent aspects of the present disclosure, and those aspects described in the detailed description below, may include any of the features, options, and possibilities set out in the present disclosure and figures, including those under the other independent aspects, and may also include any combination of any of the features, options, and possibilities set out in the present disclosure and figures.

The details of one or more implementations of the disclosure are set forth in the accompanying drawings and the description below. Other aspects, advantages, purposes, and features will be apparent upon review of the following specification in conjunction with the drawings.

### BRIEF DESCRIPTION OF THE DRAWINGS

FIG. 1 is a perspective view of an example countertop with an inductive cooktop.

FIG. 2 is a perspective view of an example disc-shaped induction coil disposed below a pan resting on an inductive cooktop.

FIG. 3 is a schematic view of an example magnetic field generated by the induction coil generated by the induction coil shown in FIG. 2.

FIG. 4 is a schematic view of an example magnetic field generated by a U-shaped induction coil.

FIG. 5 is a schematic view of an example stack of layers corresponding to the inductive cooktop of FIG. 1.

FIG. 6 is a top plan view of an example arrangement of induction coils for the inductive cooktop of FIG. 1.

FIG. 7 is an enlarged plan view of a subset of induction coils of the inductive cooktop of FIG. 6.

FIG. 8 is a schematic plan view of a four-coil array of representative inductive coils indicating opposite electromagnetic field directions.

FIG. 9 is a circuit diagram illustrating a power distribution scheme of a four coil array as in FIG. 8.

FIG. 10 is a circuit diagram illustrating an exemplary power distribution scheme of a six coil array.

FIG. 11 is a circuit diagram illustrating a first operating mode of the power distribution scheme of a six coil array shown in FIG. 10.

FIG. 12 is a circuit diagram illustrating a second operating mode of the power distribution scheme of a six coil array shown in FIG. 10.

FIG. 13 is a circuit diagram illustrating a first operating mode of the power distribution scheme of a six coil array shown in FIG. 10.

FIG. 14 is a circuit diagram illustrating an exemplary power distribution scheme of a four coil array.

FIG. 15 is a circuit diagram illustrating a first operating mode of the power distribution scheme of a four coil array shown in FIG. 14.

FIG. 16 is a schematic view of an example computing device that may be used to implement the systems and methods described herein.

Like reference symbols in the various drawings indicate like elements.

### DETAILED DESCRIPTION

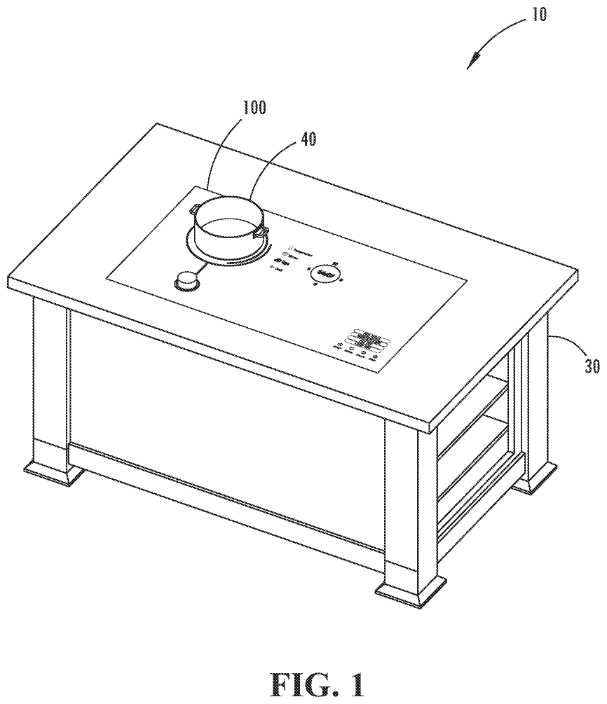

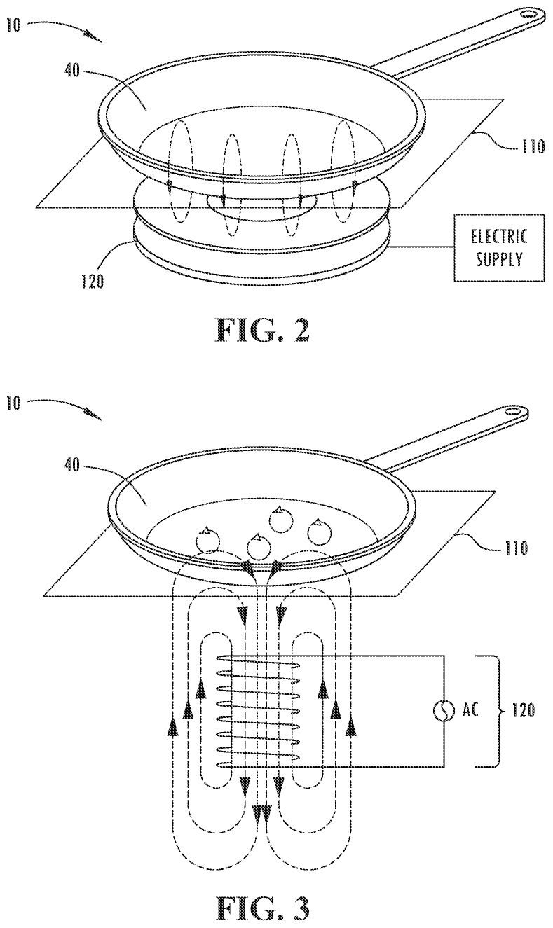

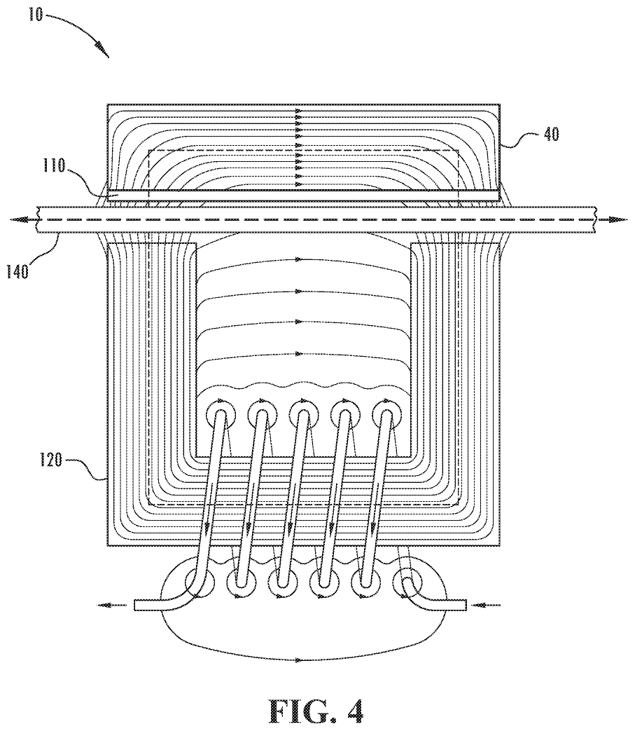

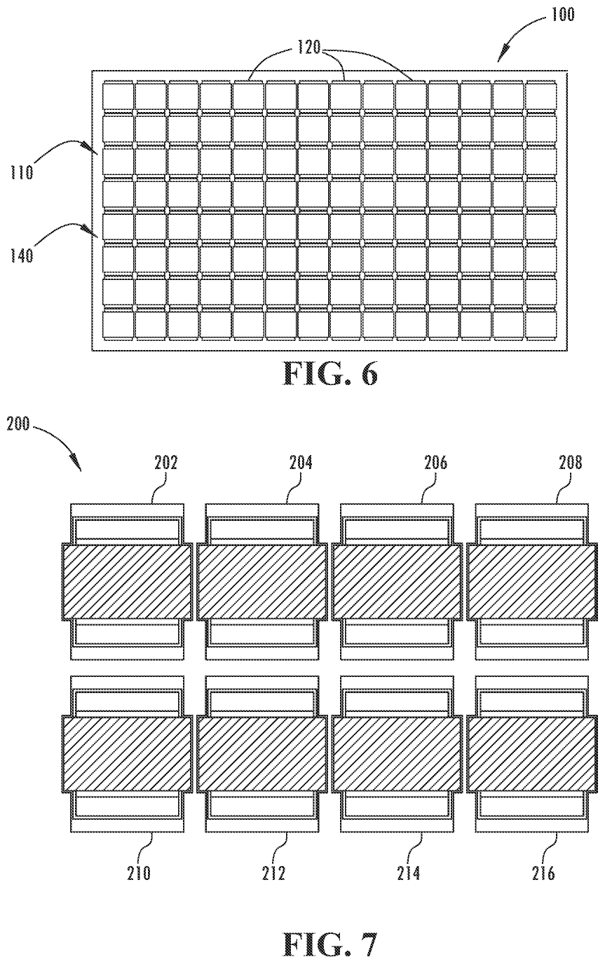

Referring to FIG. 1, an inductive cooktop 100 is provided in a kitchen environment 10 or other area used to prepare and cook food. For example, FIG. 1 illustrates the inductive cooktop system 100 installed in a countertop 20 of a cabinet 30 within the kitchen environment (e.g., a kitchen island). As shown in FIGS. 2 and 3, the inductive cooktop system 100 includes a top plate 110 (e.g., a transparent glass and/or ceramic panel) and an induction coil 120 (e.g., a solenoid coil) that is disposed below the top plate 110. Here, the induction coil 120 may refer to a solenoid coil of various shapes or configurations ranging from a C-shaped coil where each end of the “C” is adjacent to the top plate 110 (e.g., as shown in FIG. 4) to a more traditional pancake coil. The induction coil 120 may refer to a single coil or a plurality of coils (e.g., shown as an array of coils in FIGS. 6-9) below the top plate 110.

A power supply may supply alternating current, such as high-frequency or medium frequency current to the induction coil 120 to create a time varying electromagnetic (EM) field that can inductively couple with and heat a cookware object 40 e.g., a pan) supported on an upper surface of the top plate 110. The EM field may permeate through the upper surface of the top plate 110 in the area immediately above the induction coil 120, such as shown in FIGS. 2, 3, and 4. The EM field oscillates to create eddy currents in or near the bottom portion of the cookware object 40 that is supported on the top plate 110, such that the resistance of the cookware object 40 to the eddy currents causes resistive heating of the cookware object 40. Thus, the inductively heated cookware object 40 may heat and cook the contents within the cookware object 40. To adjust cooking settings, such as temperature, the power (e.g., via the current) supplied to the induction coil 120 may be adjusted.

The cookware object 40 may include a ferrous metal, such as at least at a base of the cookware object 40, to be capable of inductively coupling with the induction coil 120 and conductively spreading the heat to the cooking surface within the cookware object 40. The cookware object 40 may include various types of cooking vessels, such as a pot, a pan, an induction plate, a wok, and the like. It is also contemplated that the cookware object 40 may be product packaging, such as a metal food packaging that is configured to be used without an underlying piece of cookware. Further, it is contemplated that the other non-cookware objects may be used in place of the cookware object 40, such as an electrical or electronic device that is configured to inductively couple with the induction coil 120 to transfer data or power via the inductive coupling. Such an electrical device may include a kitchen appliance, such as a toaster or blender, a receptacle unit for plugging in other devices via electrical wires, or other personal electronic devices, such as cell phones. It should be understood that references herein to cookware object 40 includes non-cookware objects susceptible inductive coupling with the induction coil 120.

In some configurations, the system 100 includes a display element (e.g., shown as display panel 140), the configuration and/or construction of the coils 120 may aid in mitigating the coupling effects of the alternating EM field generated by the coil 120. In some examples, such as FIG. 4, the coil 120 is constructed as a U-core solenoid coil magnet to align the EM field line or flux in a given direction. Also, the induction coils in FIG. 6 include an arrangement of U-core induction coils 406 that are each positioned to align the EM fields in a common direction. By orienting the U-core solenoid coil magnet with a display element (e.g., display panel 140), metal or conductive lines in the display (e.g., the backplane of the display), which may be most vulnerable to electrical interference, are aligned parallel or generally parallel to the EM field lines. Additionally or alternatively, metal or conductive lines in the display that are identified as less vulnerable or least vulnerable to electrical interference may be aligned orthogonal to the EM field lines.

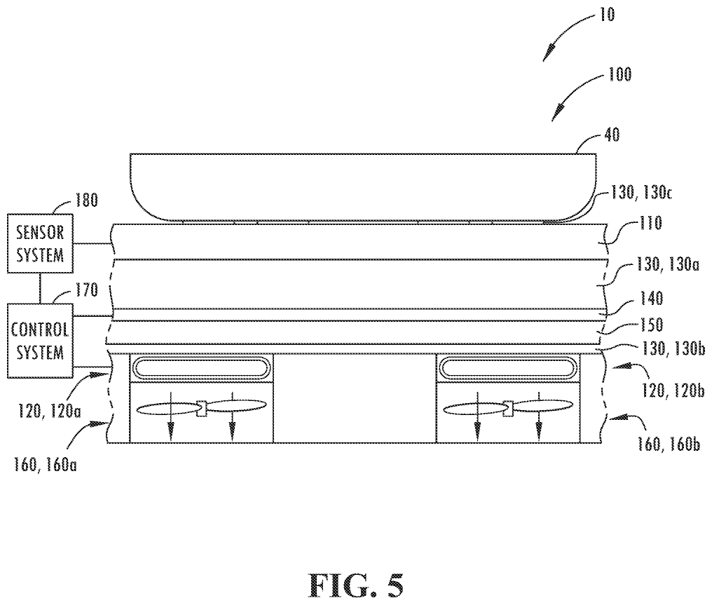

Referring to FIG. 5, the inductive cooktop system 100 may include one or more dissipation layers 130 and a display panel 140 between the cook top surface 110 and the induction coil 120 (also referred to as a coil layer 120). Here, a dissipation layer 130 may act as a thermal insulator such that heat generated by the coil layer 120, the display panel 140, and/or the cooktop surface 110 (e.g., via the cookware object 40) may be dissipated during operation of the cooktop system 100. This dissipation may help prevent malfunction and/or failure of different layers of the system 100, such as the display panel layer 140. A dissipation layer 130 may be a thermal insulating material or an air gap that allows air to flow between the layers. Here, in FIG. 5, the system 100 includes a first dissipation layer 130a between the cooktop surface 100 and the display panel 140, a second dissipation layer 130b between the display panel 140 and the coil layer 120, and a third dissipation layer 130c between the cookware object 40 and the cooktop surface 110. Although the system 100 illustrates three dissipation layers 130, 130a-c, the system 100 may include any number of dissipation layers 130. In some examples, in order to maintain the position of each layer, one or more layers of the system 100 may have structural standoffs. Additionally or alternatively, the system 100 or portions thereof may be fixed in position by a frame structure corresponding to the system 100.

Beneath the display panel 140, a support layer 150 (e.g., a glass support layer) provides a non-conducting support for the display panel 140. Below the support layer 150, a second dissipation layer 130b is shown separating the display panel 140 from the coil layer 120 (e.g., shown as two coils, 120, 120a-b). Beneath the coil layer 120, the system 100 may additionally include a cooling layer 160. For instance, each coil 120a-b includes a downdraft fan 160, 160a-b that functions to draw heat downward and away from the layers above the coil layer 120 (e.g., the display 140 or the cooktop surface 110). Additional or alternative cooling systems, such as heat sinks or liquid cooling, may be employed in additional examples to draw heat away from the coils.

The display panel 140 generally operates by coordinating the emission of light to generate graphics or other content information. For instance, based on this operation, a user perceives the emission of light as a display projected on the cooktop surface 110. Here, the display panel 140 is an organic light emitting diode (OLED) display panel that emits light using one or more OLEDs. In additional examples, the display panel may be a thin-film-transistor liquid crystal display (TFT LCD) panel, a light-emitting diode display (LED) panel, a plasma display panel (PDP) a liquid-crystal display (LCD) panel, a plasma display panel (PDP), or an electroluminescent display (ELD) panel. However, to use an OLED display panel 140 in conjunction with an induction coil layer 120, the system 100 needs to ensure that the OLED display panel 140 functions in particular operating conditions. For instance, the operation of the OLED display panel 140 may be diminished or compromised if the OLED display panel 140 is subjected to too much heat or too much electrical interference from a EM field associated with the coil layer 120.

In some examples, the inductive cooktop 100 includes a control system 170, such as control system circuitry, that is configured to detect or to receive inputs from a sensor system 180 and to perform processing tasks related to those inputs. In some configurations, the control system 170 is coupled to or in communication with the coil layer 120, the display 140, and/or the sensor system 180. For instance, the control system 170 may be physically wired to interfaces of these elements or communicate wirelessly with these elements. With respect to the display panel 140, the control system 170 is configured to control the display panel 140, such as to display information at the cooktop surface 110, including at an area or areas of the upper surface that interfaces with a cookware object 40 that is inductively coupled with an induction coil 120. The control system 170 may control information displayed by the display panel 140 before, during, or after operation of the induction coil 120 inductively coupling with a cookware object 40. Some examples of information displayed by the display panel 140 include operational information of the cooktop, outlines of cooking zones or control interfaces, control interface images, media widows or information, or branding or advertising windows or information and other conceivable images and graphics. In some implementations, to control the display 140, the control system 170 is configured to control individual pixels of the display 140 by interfacing with and controlling voltage, current, and/or other signals to a pixel circuit.

In addition to controlling the display 140, the control system 170 is configured to control the coil layer 120. Here, the control system 170 may supply power (e.g., in the form of voltage or current) to one or more coils 120 of the coil layer 120 to activate, deactivate, or adjust the characteristics of the coil 120 (e.g., adjust the heating power of one or more coils 120). In some configurations, the control system 170 includes more than one controller. Here, each controller may operate individually or communicate with each other to control some portion of the system 100. For instance, each of the display 140, the coil layer 120, and/or the sensor system 180 may include its own controller(s) that collectively form the control system 170. For example, different types of controllers may be used throughout the system 100 depending on the communication protocols required or the type of information/data that is being communicated.

FIG. 6 is an example of the inductive cooktop system 100 where the display panel 140 is transparent to illustrate the system 100. Here, a top surface of each coil 120 of the array of induction coils 120 is depicted generally within the same plane. Yet this does not have to be the case. For example, different coils 120 within the array may be at different distances from the cooktop surface 110 (e.g., a bottom surface of the cooktop surface 110). In other words, each coil 120 may be set at a particular distance to the cooktop surface 110 independent of other coils 120 within the array. In some implementations, the coils 120 are arranged in a pattern based on their distance from their top surface of the coil 120 facing the cooktop surface 100 to the cooktop surface itself. In some configurations, the coils 120 within the array are configured such that each coil 120 has some degree of adjustability in the x, y, and/or z-direction. Here, the z-direction corresponds to moving upwards or downwards with respect to the cooktop surface 110 while the x-direction corresponds to moving left or right and the y-direction corresponds to moving towards the foreground or the background.

In some examples, the coils 120 are held in a coil holder (e.g., a frame or container that supports the coils 120) where the coil holder is adjustable with respect to the cooktop surface 110 (e.g., adjustable upwards towards the cooktop surface 110 or downwards away from the cooktop surface 110). Additionally or alternatively, the system 100 may be constructed such that the display 140 is adjustable with respect to the coil layer 120. For instance, the coil layer 120 is fixed while the display 140 moves upward or downward. In other examples, both the display 140 and the coil layer 120 have some degree of adjustability within the system 100.

The coils 120 are illustrated having separate U-shaped ferrite cores having two upwardly extending arm members and a horizontal central portion extending between the arm members and around which a conductive wire is wound. This is not intended to be limiting and other configurations are contemplated to be within the scope of the present disclosure. In one example, two or more coils may be formed around a common core, such as in the form of an E-core, where the individual coils are separated by interstitial vertical arm members extending from the common horizontal core. In another example, three coils may be formed around a common core. In another example, all of the coils making up one column of the cooktop 100 may share a common core. In the illustrated implementation, the cooktop 100 comprises eight coils in each of fourteen columns. In other alternatives, more or fewer rows or columns may be used depending on the desired size of the appliance or the size of the coils.

FIG. 7 illustrates a coil array 200 that comprises a subset of induction coils 120 of the inductive cooktop 100. The coil array 200 comprises eight coils 202, 204, 206, 208, 210, 212, 214, 216, arranged in two rows by four columns. A subset of induction coils 120 of the inductive cooktop 100, such as coil array 200, may constitute a discrete area of the inductive cooktop 100 corresponding to a common geometry for use with a cookware object 40. It may be desirable to operate the coil array 200 while the remaining coils 120 of the inductive cooktop 100 remain unpowered. Other subsets of coils may be likewise grouped to create multiple discrete areas of operation of the cooktop 100. In one example, fewer coils may be grouped where the coils have a larger footprint relative to the inductive cooktop 100, occupying a larger portion of the cooktop 100 surface, or where a smaller cooktop object 40 is used. In another example, more coils 120 may be grouped where the individual coil is smaller, or where a larger cooktop object 40 is used. The coils of the coil array 200 may be formed on separate U-shaped cores or may be formed on one or more shared E-shaped cores.

The coils of a coil array 200 may be driven individually or cooperatively with one or more drivers. For example, each coil may be electronically coupled in series with a separate driver and capacitor. Each separate driver may in turn be coupled to a controller and controlled individually. Alternatively, multiple coils, and in particular multiple adjacent coils, may be coupled in series with a single or multiple drivers, coupled with a controller, so that multiple coils can be controlled cooperatively. FIG. 8 shows one example of a subset of the coil array 200 with four similar U-shaped coil assemblies 202, 204, 210, 212, wherein each coil is constructed similarly, and each coil has current flowing in a direction opposite to the current flow direction of the adjacent coils. Using subsets of coils in cooperation, a cooktop system may be configured in a flexible manner by selecting various numbers of coils to increase or decrease the active area or delivered power. Using coils of opposite polarities in a vertical column, i.e., coils 202, 210, the lines of flux created within a row of coils has a reduced impact on the flux created within an adjacent row since the opposing pole configuration at any given point in time crease opposing forces.

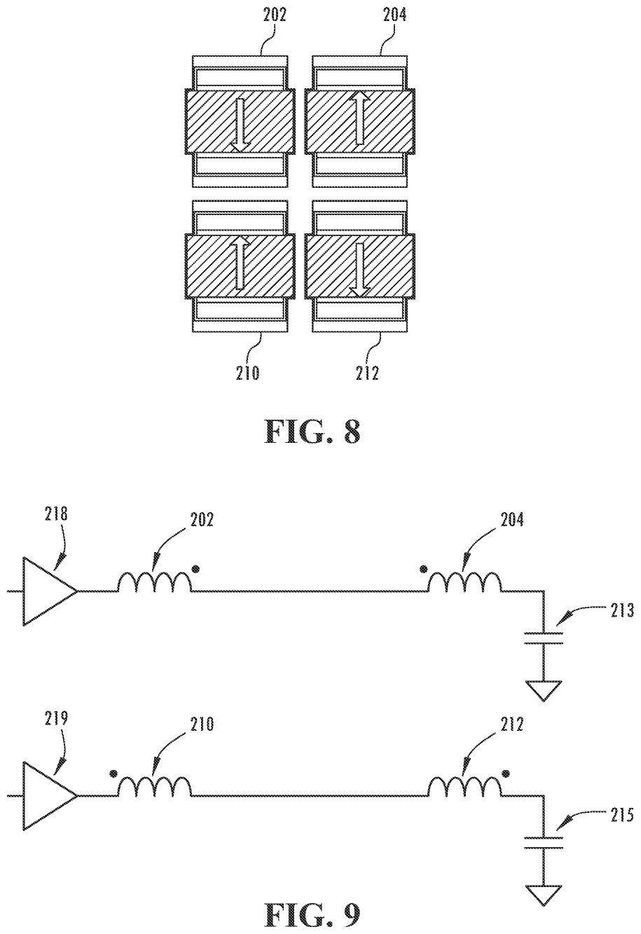

FIG. 9 shows an example of a driver configuration for a four coil array, 202, 204, 210, 212, wherein two coils within a row are wound in opposing direction and connected in series. Alternatively, the two coils may be wound identically but connect in series so that the negative terminal of one coil is connected to the negative terminal of the adjacent coil or so that the positive terminal of one coil is connected to the positive terminal of the adjacent coil. The two adjacent coils may be adjacent vertically in the coil array 200 or adjacent horizontally in the coil array 200. In this configuration, adjacent coils connected in series operate so that the current flowing through the adjacent coils is equal in magnitude. This arrangement creates a more even electromagnetic field that results in less induced voltage in surrounding coils or other electronics, such as display panel 140.

The subset of coils 202, 204, 210, 212 as illustrated in FIGS. 8 and 9 may be driven with a pair of drivers 218, 219 with a pair of coils connected in series with a resonant capacitors 213, 215. In another alternative, the coils 202, 204, 210, 212 may be drive with a single driver with the series connections of two coils, e.g., coils 202 and 204, being connected in parallel with the series connections of the other two coils, e.g., coils 210 and 212. Similarly, all four coils may be connected in series with a single resonant capacitor to create a single resonant network, operating with an even current distribution within the entire array. Reducing the number of component comprising the system may simplify the control strategy and lower the overall cost of the system. Where coils of the coil array 200 are implemented using a common E-shaped ferrite core, windings may be done in opposing directions to obtain a configuration as illustrated in FIGS. 8 and 9.

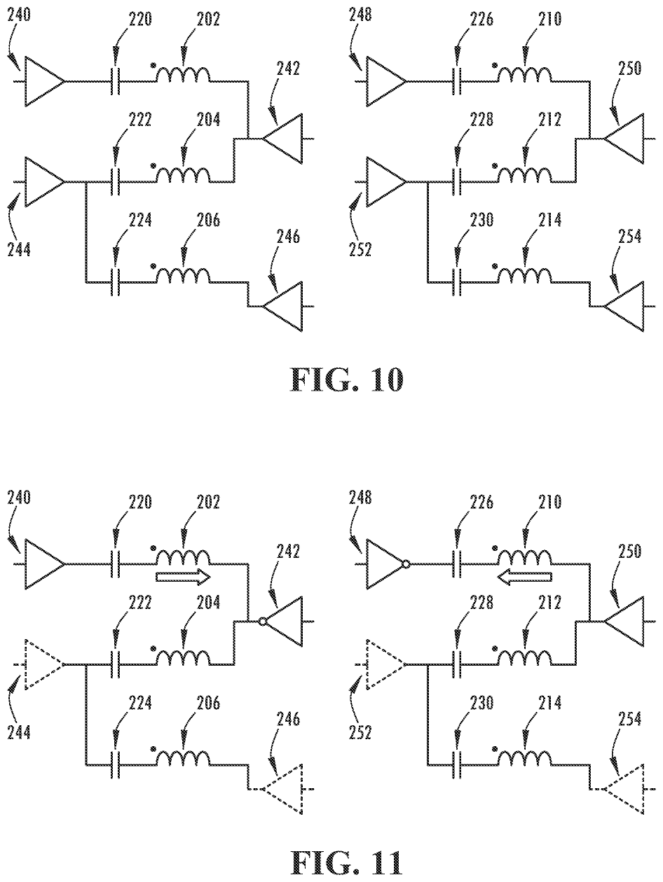

FIG. 10 illustrates a circuit diagram where the coils 202, 204, 206, 210, 212, 214 are wired in series with alternating polarities, with each coil 202, 204, 206, 210, 212, 214 having its own series resonant capacitor 220, 222, 224, 226, 228, 230. A driver 240, 242, 244, 246, 248, 250, 252, 254 is placed between at each end of the series and at each connection point between the coils. In this arrangement, coils may still be driven individually by selecting driving on either side of a single coil. In addition, coils may be driven in series of two or more coils by selecting the appropriate drivers. Multiple individual or series of coils formed around a common ferrite core can be driven without interference where there is no common node between the driven coils. If coils are drive in an even number of coils in series, every other capacitor may be omitted from the circuit, leaving one coil in series for every two coils in each configuration.

FIG. 11 illustrates the circuit diagram of FIG. 10 in a first operating mode. In the illustrated first operating mode, a first coil 202 and a second coil 210 are selected for operation. The first driver 240 drives the first coil 202 in a first polarity and a second driver 242 drives the first coil in the opposite polarity. Similarly, a third driver 248 and fourth driver 250 drives the second coil 210 in the opposite direction to the first coil 202. In this way, the two adjacent coils 201, 210 can be driven with current equal in amplitude but opposite in phase. This can minimize or eliminate current in the non-driven coils.

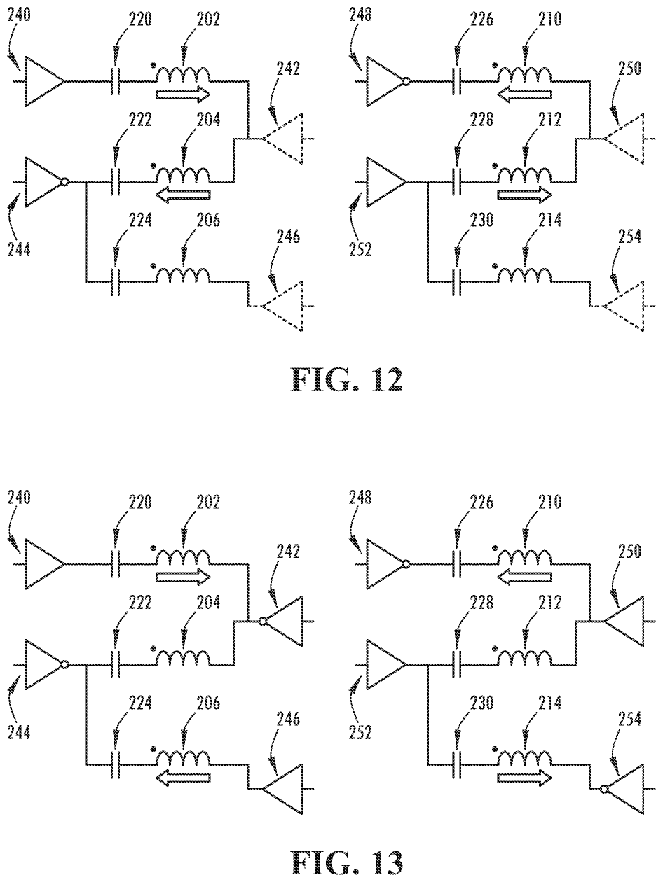

FIG. 12 illustrates the circuit diagram of FIG. 10 in a second operating mode. In the second operating mode two pairs of two coils placed in series are driven in opposite directions. Specifically, the first coil 202 and a second coil 204, in series with first coil 202, and one or two resonant capacitors 220, 222 in series with the coils, are driven by a first driver 240 operating in a first polarity and by a second driver 244 operating in the opposite polarity. A third coil 210 and a fourth coil 212 in series with the third coil 210, and one or two resonant capacitors 226, 228 in series with the coils, are driven by a third driver 248 operating in the same polarity as the second driver 244, opposite the first driver, and a fourth driver 250 operating opposite the third driver 248, in polar parity with the first driver. FIG. 12 demonstrates how the present disclosure can be scale to incorporate increase numbers of coils so that adjacent coils are operated with current equal in amplitude by opposite in phase.

FIG. 13 illustrates the circuit diagram of FIG. 10 in a third operating mode. In the third operating mode the two nonadjacent coils in the three-coil series are operated while the middle coil in the three-coil series is not operated. As illustrated in FIG. 13, the first driver 240 drives the first coil 202 at a first polarity. The second driver 242 is connected in series with the first coil 202 and driven in the opposite polarity to the first driver 240. A second coil 204 is in series with the second driver 242 and a third driver 244. The third driver 244 is operated at the same polarity as the second driver 242 making the voltage across the second coil 204 effectively zero. A third coil 206 is in series with the third driver 244 and the fourth driver 246. The fourth driver 246 is drives the third coil 206 with the same polarity as the first driver 240, resulting in an operation of the third coil 206 equal in magnitude but opposite in phase as the first coil 202. A similar operation is applied in the second series of drivers 248, 250, 252, 254 and coils 210, 212, 214, but with an opposite polarity so that the first coils 202, 210 in the series are operated with opposite phase.

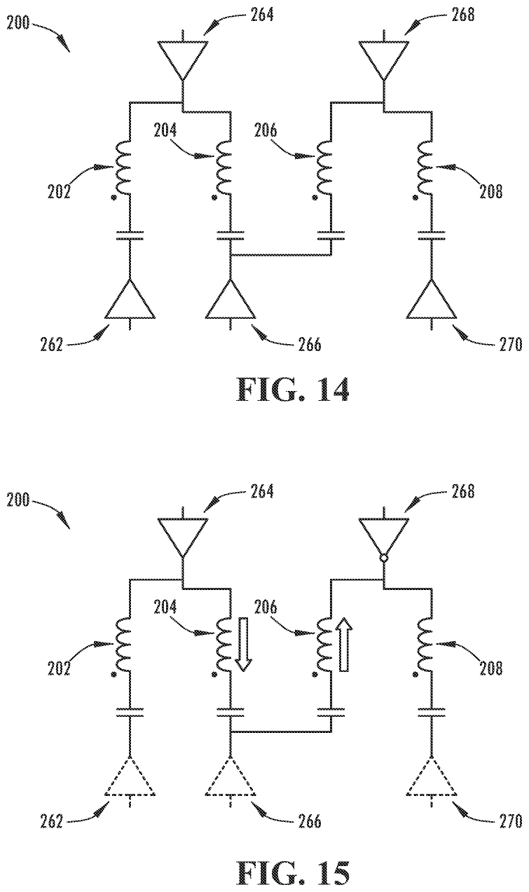

FIG. 14 illustrates a circuit diagram for operating an exemplary power distribution scheme for a four-coil series 260 including four coils 202, 204, 206, 208, and five drivers 262, 264, 266, 268, 270. FIG. 14 illustrates another implementation expanding the present disclosure to encompass increasing number of coils operated cooperatively to minimize interference in adjacent unpowered coils and provide increasing flexibility in selectively operating discrete areas of the cooktop 100. The illustrated circuit FIG. 15 illustrates one exemplary mode of operation where the middle two coils 204, 206 are selectively powered and the end coils 202, 208 are unpowered. Two of the drivers 264 and 268 are selectively driven with opposite polarity while the other drivers 262, 266, and 270 remain unpowered. A similar arrangement may be implements in adjacent series of coils to obtain pairs of adjacent coils operated with current equal in amplitude and opposite in phase.

The disclosed arrangements illustrate scalable implementations to selectively operate discrete regions in an inductive cooktop system to achieve greater efficiency in power utilization by powering only those coils needed for the desired operation, and minimizing potential interference and reactive current generation in proximate non-driven induction coils of the cooktop system.

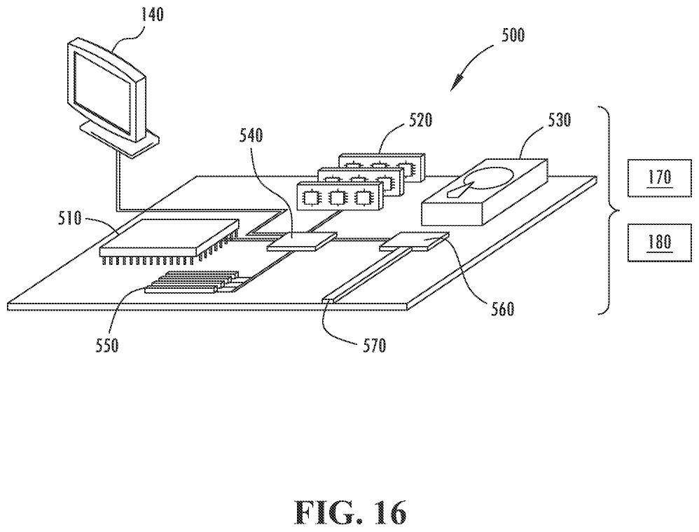

FIG. 16 is schematic view of an example computing device 500 that may be used to implement the systems (e.g., systems 100) and methods described in this document. The computing device 500 is intended to represent various forms of digital computers/processors, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 500 includes a processor 510 (e.g., data processing hardware), memory 520 (e.g., memory hardware), a storage device 530, a high-speed interface/controller 540 connecting to the memory 520 and high-speed expansion ports 550, and a low speed interface/controller 560 connecting to a low speed bus 570 and a storage device 530. Each of the components 510, 520, 530, 540, 550, and 560, are interconnected using various busses, and may be mounted on a common circuit board, such as a motherboard, or in other manners as appropriate. The processor 510 can process instructions for execution within the computing device 500, including instructions stored in the memory 520 or on the storage device 530 to display graphical information for a graphical user interface (GUI) on an external input/output device, such as display 140 coupled to high speed interface 540. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 520 stores information non-transitorily within the computing device 500. The memory 520 may be a computer-readable medium, a volatile memory unit(s), or non-volatile memory unit(s). The non-transitory memory 520 may be physical devices used to store programs (e.g., sequences of instructions) or data (e.g., program state information) on a temporary or permanent basis for use by the computing device 500. Examples of non-volatile memory include, but are not limited to, flash memory and read-only memory (ROM)/programmable read-only memory (PROM)/erasable programmable read-only memory (EPROM)/electronically erasable programmable read only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 530 is capable of providing mass storage for the computing device 500. In some implementations, the storage device 530 is a computer-readable medium. In various different implementations, the storage device 530 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 520, the storage device 530, or memory on processor 510.

The high speed controller 540 manages bandwidth-intensive operations for the computing device 500, while the low speed controller 560 manages lower bandwidth intensive operations. Such allocation of duties is exemplary only. In some implementations, the high-speed controller 540 is coupled to the memory 520, the display 580 (e.g., through a graphics processor or accelerator), and to the high-speed expansion ports 550, which may accept various expansion cards (not shown). In some implementations, the low-speed controller 560 is coupled to the storage device 530 and a low-speed expansion port 590. The low-speed expansion port 590, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device (e.g., the display 140) or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature; may be achieved with the two components (electrical or mechanical) and any additional intermediate members being integrally formed as a single unitary body with one another or with the two components; and may be permanent in nature or may be removable or releasable in nature, unless otherwise stated.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional implementations that also incorporate the recited features. Furthermore, the terms “first,” “second,” and the like, as used herein do not denote any order, quantity, or importance, but rather are used to denote element from another.

Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. For example, the terms “approximately,” “about,” and “substantially” may refer to an amount that is within less than 5% of, within less than 1% of, within less than 0.1% of, and within less than 0.01% of a stated amount.

Further, it should be understood that any directions or reference frames in the preceding description are merely relative directions or movements. For example, the terms “upper,” “lower,” “right,” “left,” “rear,” “front,” “vertical,” “horizontal,” “inboard,” “outboard” and derivatives thereof shall relate to the orientation shown in FIG. 1. However, it is to be understood that various alternative orientations may be provided, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. An inductive cooktop comprising:
a transparent panel configured to support a cookware object; and
an induction coil layer disposed below the transparent panel, the induction coil layer operable to generate a time varying electromagnetic field that inductively couples with the cookware object supported at the transparent panel; and
the induction coil layer comprising a plurality of induction coils;
wherein the induction coil layer is configured to operate a first coil of the plurality of induction coils to generate a first electromagnetic field of a first magnitude and first polarity and to operate a second coil to generate a second electromagnetic field of a second magnitude and second polarity, the second coil being adjacent the first coil, the first magnitude being equal the second magnitude, and the first polarity being opposite the second polarity.

2. The inductive cooktop of claim 1, further comprising a plurality of drivers in electronic communication with the plurality of induction coils, wherein a first driver is connected in series with the first coil and the second coil, and wherein the first coil comprises windings oriented in a first direction and the second coil comprises windings oriented in a second direction opposite the first direction.

3. The inductive cooktop of claim 1, further comprising a plurality of drivers in electronic communication with the plurality of induction coils, wherein a first driver is connected in series with a first terminal of the first coil, a second terminal of the first coil being connected in series to a first terminal of the second coil, wherein the second terminal of first coil is the same polarity as the first terminal of the second coil.

4. The inductive cooktop of claim 1, wherein the first coil is driven with a first current having a first frequency and first phase; the second coil is driven with a second current having a second frequency and second phase; and wherein the first phase is opposite the second phase.

5. The inductive cooktop of claim 1, wherein the first coil and the second coil are formed on a common E-shape ferrite core.

6. The inductive cooktop of claim 5, wherein the common E-shape ferrite core comprises a first end vertical arm member; a second end vertical arm member; a horizontal portion extending between the first end vertical arm member and second end vertical arm member; a first interstitial vertical arm member extending from the horizontal portion disposed between the first end vertical arm member and the second end vertical arm member; a first coil formed between the first end vertical arm member and the first interstitial vertical arm member; and a second coil formed between the first interstitial vertical arm member and the second end vertical arm member.

7. The inductive cooktop of claim 6, wherein the first coil comprises windings around the horizontal portion wound in a first direction and wherein the second coil comprises windings around the horizontal portion wound in a second direction opposite the first direction.

8. The inductive cooktop of claim 1, further comprising a plurality of drivers in electronic communication with the plurality of induction coils, wherein the plurality of induction coils and plurality of drivers comprise a circuit of a first driver, a first coil, a second coil and a second driver connected in series, wherein a third driver is connected at a junction between first coil and the second coil.

9. The inductive cooktop of claim 8, wherein the circuit further comprises a third coil disposed in series between the second coil and the second driver; and a fourth driver connected at a junction between the second coil and the third coil.

10. The inductive cooktop of claim 9, wherein the circuit further comprises a fourth coil disposed in series between the third coil and the second driver; and a fifth driver connected at a junction between the third coil and the fourth coil.

11. The inductive cooktop of claim 9, wherein the circuit comprises a first resonant capacitor disposed in series between the first driver and the first coil; a second resonant capacitor disposed in series between the second coil and the third driver; and a third resonant capacitor disposed in series between the third coil and the third driver.

12. The inductive cooktop of claim 8, wherein the first coil comprises a U-shape ferrite core comprising a first vertical arm member and a second vertical arm member and a horizontal portion extending between the first vertical arm member and second vertical arm member; and a conductive wire wound around the horizontal portion.

13. The inductive cooktop of claim 9, wherein the first coil, the second coil, and the third coil are formed on a common E-shape ferrite core.

14. The inductive cooktop of claim 13, wherein the common E-shape ferrite core comprises a first end vertical arm member; a second end vertical arm member; a horizontal portion extending between the first end vertical arm member and second end vertical arm member; a first interstitial vertical arm member extending from the horizontal portion disposed between the first coil and the second coil; and a second interstitial vertical arm member extending from the horizontal portion disposed between the second coil and the third coil.

15. The inductive cooktop of claim 14, wherein the first coil comprises windings around the horizontal portion wound in a first direction, the second coil comprises windings around the horizontal portion wound in a second direction, the second direction being opposite the first direction, and the third coil comprises windings around the horizontal portion in a third direction, the third direction being the same as the first direction.

16. The inductive cooktop of claim 9, wherein the circuit is a first circuit, the inductive cooktop further comprising a second circuit, the second circuit comprising a fifth driver, a fourth coil, a fifth coil, a sixth coil and a sixth driver connected in series, wherein a seventh driver is connected at a junction of the fourth coil and the fifth coil and an eighth driver is connected at a junction of the fifth coil and the sixth coil.

17. The inductive cooktop of claim 16, wherein the first coil is adjacent the fourth coil, the second coil is adjacent the fifth coil, and the third coil is adjacent the sixth coil in the induction coil layer.

18. A method of operating an induction cooktop, the induction cooktop comprising a transparent panel configured to support a cookware object and an induction coil layer disposed below the transparent panel, the coil layer comprising a first circuit comprising a first driver, a first coil, a second coil, a third coil and a second driver connected in series, wherein a third driver is connected at a junction between first coil and the second coil and a fourth driver is connected at a junction between the second coil and the third coil; and a second circuit comprising a fifth driver, a fourth coil, a fifth coil, a sixth coil and a sixth driver connected in series, wherein a seventh driver is connected at a junction of the fourth coil and the fifth coil and an eighth driver is connected at a junction of the fifth coil and the sixth coil, the method comprising:
driving the first coil with the first driver operating at a first polarity and the third driver operating at a second polarity opposite the first polarity; and
driving the fourth coil with the fifth driver operating at the second polarity and the seventh driver operating at the first polarity.

19. The method of operating an induction cooktop of claim 18, further comprising:
driving the third coil with the fourth driver operating at the second polarity and the second driver operating at the first polarity, wherein a voltage across the second coil is substantially zero; and
driving the sixth coil with the eighth driver operating at the first polarity and the sixth driver operating at the second polarity, wherein a voltage across the fifth coil is substantially zero.

20. A method of operating an induction cooktop, the induction cooktop comprising a transparent panel configured to support a cookware object and an induction coil layer disposed below the transparent panel, the coil layer comprising a first circuit comprising a first driver, a first coil, a second coil, a third coil and a second driver connected in series, wherein a third driver is connected at a junction between first coil and the second coil and a fourth driver is connected at a junction between the second coil and the third coil; and a second circuit comprising a fifth driver, a fourth coil, a fifth coil, a sixth coil and a sixth driver connected in series, wherein a seventh driver is connected at a junction of the fourth coil and the fifth coil and an eighth driver is connected at a junction of the fifth coil and the sixth coil, the method comprising:
driving the first coil and the second coil with the first driver operating at a first polarity and the fourth driver operating at a second polarity opposite the first polarity; and
driving the fourth coil and the fifth coil with the fifth driver operating at the second polarity and the eighth driver operating at the first polarity.
